(19) United States
(12) Patent Application Publication
(10) Pub. No.: US 2005/0055856 A1
(43) Pub. Date: Mar. 17, 2005

(54) Illiminated address sign

(76) Inventors: David Brian Johnston, Bristol, CT (US); Mark Lawrence Kulas, Unionville, CT (US); Ben Russell, Wolcott, CT (US)

Correspondence Address: DAVID JOHNSTON, 25 DWIGHT ST., BRISTOL, CT, 06010, US

(21) Appl. No.: 10/662,378

(22) Filed: Sep. 16, 2003

(51) Int. Cl. G09F 13/22

(52) U.S. Cl. 40/544

(57) ABSTRACT

A new illuminated address sign for displaying a street address. A box like enclosure, of suitable size to be visible, that will use electroluminescent lighting technology to provide illumination for numbers, letters, and or symbols on the front face of said enclosure. The illuminated address sign can be used at home, business, or municipal addresses.

### REFERENCES CITED

(Referenced by)

| | | | |
|---|---|---|---|
| 1192982 | August 1916 | Bristol et al. | 40/552 |
| 1462156 | July, 1923 | Trucksess | 40/130 |
| 1760767 | May, 1930 | Muller | 40/130 |
| 1782564 | November 1930 | Coufal et al | 362/812 |

### FIELD OF THE INVENTION

This invention relates to an address sign and the use of an electroluminescent light source as a way of illuminating numbers, letters, and or symbols made of said material or uses electroluminious material as a background to which opaque numbers letters, and or symbols can be affixed.

### BACKGROUND OF INVENTION

The use of illuminated address signs is known in prior art but their source of illumination has such power consumption that it can not sustain battery operation for more than a short time, making the use of batteries prohibitive.

Light sources such as light-emitting diodes are disclosed in U.S. Pat. No. 4,903,172 to Schoniger et al., and U.S. Pat. No. 5,265,411 to Rycroft et al. Though light emitting-diodes are semi-efficient they use much more energy than equivalent amounts of surface illumination as needed to illuminate a number, letter, and or symbol as needed for use in an address sign.

### SUMMARY OF THE INVENTION

According to the present invention this illuminated address sign uses very efficient electroluminescent lighting technology for visible illumination of numbers, letters, and or symbols affixed to or made of electroluminescence material and is designed to use very small amounts of electricity to illuminate said features. Numbers, letters, and or symbols either made of the electroluminescent material or electroluminescence material will be used, as a backing plate for illumination to which opaque numbers, letters, and or symbols will be affixed. The illuminated address sign will have the appropriate electronic circuitry to provide power to the electroluminescence numbers, letters, and or symbols. The electronic circuitry will also have encapsulated in it a feature to turn the unit on at low light conditions and off at higher light conditions. Electroluminescent lighting uses comparatively so little energy that batteries can now power this unit for the first time. The unit can also be powered by line voltage. The unit will be affixed to a location on a home, building, mailbox or the like so as to display the address of the location.

### BRIEF DESCRIPTION OF THE DRAWING

FIG. 1 is a perspective view of the illuminated address sign assembly shown from the upper right side.

FIG. 2 is a view directly from the front showing the numbers 22 displayed as an address location.

FIG. 3 is a partial cutaway view of the cover housing from the right side.

FIG. 4 is a back view of the address sign assembly; showing the back of the cover-housing and back plate.

FIG. 5 is an exploded view of the entire assembly.

### DESCRIPTION OF THE PREFERED EMBODIMENT

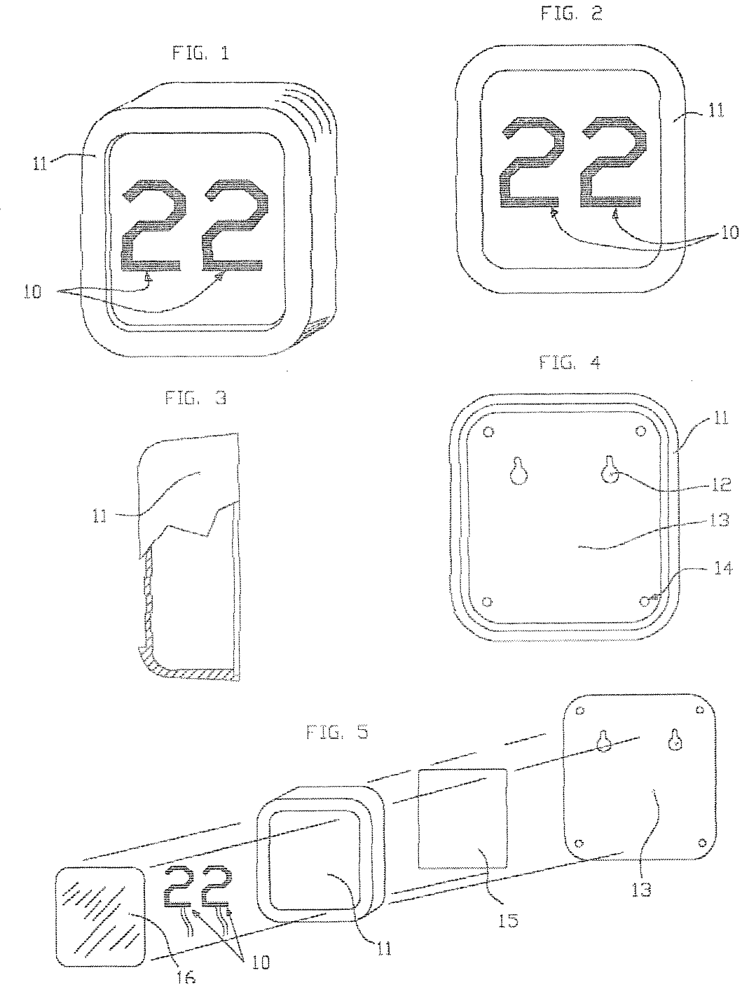

Referring to FIG. 1. It shows and isometric view of the illuminated address sign, shown from the upper right hand corner. The numbers 10 are shown made of electroluminescence material and shown affixed to the front side of the cover-housing 11 portion of the assembly. The front face of the cover housing 11 is recessed slightly to protect the numbers and for design purposes.

Referring to FIG. 2. This front view shows the numbers 10 affixed to the front face of the cover housing 11.

FIG. 3. Is a view from the right side of the cover housing 11. Shown with the lower portion of the cover housing 11 split down the middle to show the recess in the front portion of the cover housing 11 and stepped area to which the backing plate (not shown) will be attached. In this formed cavity the appropriate electronic circuitry will be attached.

FIG. 4. Shows the back view of the illuminated address sign assembly with provisions of two mounting holes 12 in the back plate 13 to provide a means to attach the said unit to the home, business, mailbox or like surface. The back plate 13 is mounted to the cover housing 11 by means of four fasteners 14 located in the corners of back plate 13

FIG. 5. Is an exploded view of the illuminated address sign. From right to left we have backing plate 13 which when assembled will house appropriate circuitry on circuit board 15, to which will be encapsulated in a cover housing 11. The electroluminious numbers 10 shown with wires attached will be threaded thru or have like provisions to be

attached to the circuit board 15 and transparent cover plate 16 will then be affixed.

While certain preferred embodiments of the present invention have been disclosed in detail, it must be understood that modifications in its structure may be adapted without departing from the spirit of this invention or the scope of the following claims.

1. An automated illuminated address sign that uses electroluminescent lighting material for illumination. Numbers, letters, and or symbols made of said material will be of suitable size, when affixed on the address sign assembly, to which when used at a property location will be visible during daylight hours and will be illuminated during low light conditions for address identification comprising:
A housing having four sides, a front and back portion, and an interior cavity that will house the needed electronic components.
A electronic circuit that will control the operation of said electroluminious lamp material.
A series of numbers, letters, and symbols made of electroluminious material that will be affixed to the front face of said housing that will illuminate at low light conditions and be visible during daytime hours.

2. An automated illuminated address sign that uses electroluminescent lighting material for illumination as stated in claim one wherein:
A electronic circuit to turn the power on at low light conditions and off at higher light conditions, and be powered by battery, solar or line voltage.

3. An automated illuminated address sign that uses electroluminescent lighting material for illumination as stated in claim one wherein:
opaque numbers, letters, and or symbols will be affixed to an electroluminescent planer plate.
